(19) United States
(12) Patent Application Publication
(10) Pub. No.: US 2025/0349862 A1
(43) Pub. Date: Nov. 13, 2025

(54) ELECTRODE FOR SECONDARY BATTERY, ELECTRODE ASSEMBLY, AND METHODS OF MANUFACTURING ELECTRODE AND ELECTRODE ASSEMBLY

(71) Applicant: SAMSUNG SDI CO., LTD., Yongin-si (KR)

(72) Inventor: Jeawoan LEE, Yongin-si (KR)

(21) Appl. No.: 18/939,995

(22) Filed: Nov. 7, 2024

(30) Foreign Application Priority Data
May 8, 2024 (KR) 10-2024-0060690

(51) Int. Cl. H01M 4/66; H01M 4/13; H01M 50/534

(52) U.S. Cl. CPC H01M 4/667; H01M 4/13; H01M 4/661; H01M 4/668; H01M 50/534

(57) ABSTRACT

The present disclosure relates to an electrode for a secondary battery, an electrode assembly, and a method for manufacturing the same. The electrode may comprise a substrate layer including a polymer layer, a first metal layer disposed on a first surface of the polymer layer, and a second metal layer disposed on a second surface of the polymer layer opposite to the first surface, with the second metal layer comprising a different metal from the first metal layer. The electrode may further comprise a first active material layer disposed on the first metal layer, and a second active material layer disposed on the second metal layer. The substrate layer may comprise a first uncoated portion where the first metal layer is exposed and a second uncoated portion where the second metal layer is exposed.

### CROSS REFERENCE TO RELATED APPLICATION

The present application claims priority to and the benefit of Korean Application No. 10-2024-0060690, filed on May 8, 2024, in the Korean Intellectual Property Office, the entire disclosure of which is incorporated by reference herein.

### BACKGROUND

### 1. Field

The present disclosure relates to an electrode for a secondary battery, an electrode assembly, and methods of manufacturing an electrode and an electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In order to miniaturize secondary batteries and/or increase the energy density of secondary batteries, it is desirable to reduce the size of electrodes used in the batteries. In the fabrication of respective electrode layers, a substrate layer is formed by coating both sides of a polymer layer with thin films of collector metal, thereby reducing the size of the electrode layers.

The above information disclosed in this Background section is for enhancement of understanding of the background of the present disclosure, and therefore, it may contain information that does not constitute related (or prior) art.

### SUMMARY

An aspect of the present disclosure is to provide an electrode for a secondary battery, an electrode assembly, and methods of manufacturing an electrode and an electrode assembly.

These and other aspects and features of the present disclosure will be described in or will be apparent from the following description of embodiments of the present disclosure.

To realize at least one of the above objectives, an electrode according to one or more embodiments of the present disclosure may comprise a substrate layer including a polymer layer, a first metal layer disposed on a first surface of the polymer layer, and a second metal layer disposed on a second surface of the polymer layer that is opposite to the first surface and comprising a different metal from the first metal layer, a first active material layer disposed on the first metal layer, and a second active material layer disposed on the second metal layer, wherein the substrate layer includes a first uncoated portion where the first metal layer is exposed and a second uncoated portion where the second metal layer is exposed.

According to one or more embodiments of the present disclosure, the first uncoated portion is provided at a first end of the substrate layer in a longitudinal direction of the substrate layer, and the second uncoated portion is provided at a second end of the substrate layer.

According to one or more embodiments of the present disclosure, the first metal layer comprises a tab-forming portion protruding in a transverse direction of the first metal layer.

According to one or more embodiments of the present disclosure, the substrate layer comprises a tab formed by the tab-forming portion and a portion of the polymer layer corresponding to the first tab-forming portion.

According to one or more embodiments of the present disclosure, the tab-forming portion is a first tab-forming portion, and the second metal layer further comprises a second tab-forming portion protruding in a transverse direction of the second metal layer.

According to one or more embodiments of the present disclosure, the tab is a first tab, and the substrate layer comprises a second tab formed of the second tab-forming portion and a portion of the polymer layer corresponding to the second tab-forming portion.

According to one or more embodiments of the present disclosure, wherein the first tab comprises a plurality of first tabs and the second tab comprises a plurality of second tabs, and the first tabs and the second tabs are arranged in the longitudinal direction of the substrate layer.

According to one or more embodiments of the present disclosure, the first tabs and the second tabs are alternately disposed.

According to one or more embodiments of the present disclosure, the first uncoated portion and the second uncoated portion are disposed on the same side of the substrate layer.

According to one or more embodiments of the present disclosure, the substrate layer comprises a first tab and a second tab protruding in opposite directions with respect to a transverse direction of the substrate layer.

According to one or more embodiments of the present disclosure, the first metal layer and the second metal layer are deposited on the polymer layer.

To realize at least one of the above objectives, an electrode assembly according to one or more embodiments of the present disclosure may comprise a plurality of electrodes, and separators disposed between the electrodes, wherein each of the electrodes comprises: a substrate layer including a polymer layer, a first metal layer disposed on a first surface of the polymer layer, and a second metal layer disposed on a second surface of the polymer layer that is opposite to the first surface, the second metal layer comprising a different metal from the first metal layer; a first active material layer disposed on the first metal layer, and a second active material layer disposed on the second metal layer, wherein the substrate layer includes a first uncoated portion where the first metal layer is exposed and a second uncoated portion where the second metal layer is exposed.

To realize at least one of the above objectives, a method of manufacturing an electrode according to one or more embodiments of the present disclosure may comprise forming a substrate layer by disposing a first metal layer on a first surface of a polymer layer and disposing a second metal layer on a second surface of the polymer layer that is opposite to the first surface, the second metal layer comprising a different metal from the first metal layer, disposing a first active material layer on the first metal layer to form a first uncoated portion on the substrate layer; and disposing a second active material layer on the second metal layer to form a second uncoated portion on the substrate layer.

According to one or more embodiments of the present disclosure, the first uncoated portion is provided at a first end of the substrate layer in a longitudinal direction of the substrate layer, and the second uncoated portion is provided at a second end of the substrate layer.

According to one or more embodiments of the present disclosure, forming the substrate layer further comprises disposing the first metal layer on a portion of the polymer layer to form a tab-forming portion protruding in a transverse direction of the first metal layer.

According to one or more embodiments of the present disclosure, the method further comprises forming a tab by cutting the substrate layer corresponding to the tab-forming portion.

According to one or more embodiments of the present disclosure, the tab-forming portion is a first tab-forming portion, and the forming the substrate layer further comprises disposing the second metal layer on a portion of the polymer layer to form a second tab-forming portion protruding in a transverse direction of the second metal layer.

According to one or more embodiments of the present disclosure, the tab is a first tab, and the method further comprises forming a second tab by cutting the substrate layer corresponding to the second tab-forming portion.

According to one or more embodiments of the present disclosure, the method the forming the substrate layer comprises depositing the first metal layer on the first surface and depositing the second metal layer on the second surface.

According to one or more embodiments of the present disclosure, the method the first metal layer comprises aluminum (Al) and the second metal layer comprises copper (Cu).

According to embodiments of the present disclosure, the energy density of the secondary battery may be increased.

According to embodiments of the present disclosure, the size of the electrode may be reduced.

According to embodiments of the present disclosure, the positive electrode and the negative electrode may be integrated, thereby improving the structural stability of the electrodes.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a cross-sectional view showing an example of a secondary battery according to embodiments of the present disclosure.

FIG. 2 is a perspective view showing an example of an electrode according to embodiments of the present disclosure.

FIG. 3 is a cross-sectional view showing the cross-section of the electrode of FIG. 2, taken along line X-X′.

FIG. 4 is an exploded view showing the electrode of FIG. 2.

FIG. 5 is a plan view showing positions at which the electrode of FIG. 2 is to be cut to form electrode tabs.

FIG. 6 illustrates the electrode cut along the cut line of FIG. 5 to form the tabs.

FIG. 7 illustrates the cross-section cut along line A-A′ of FIG. 6.

FIG. 8 illustrates the cross-section cut along line B-B′ of FIG. 6.

FIG. 9 is an exploded view showing an electrode according to embodiments of the present disclosure.

FIG. 10 is a plan view showing positions at which the electrode of FIG. 9 is to be cut to form electrode tabs.

FIG. 11 illustrates the electrode cut along the cut line of FIG. 10 to form the tabs.

FIG. 12 illustrates the cross-section cut along line C-C′ of FIG. 12.

FIG. 13 illustrates the cross-section cut along line D-D′ of FIG. 12.

FIG. 14 illustrates a cross-sectional view showing the cross-section of an electrode according to embodiments of the present disclosure.

FIG. 15 is an exploded perspective view of the electrode of FIG. 14.

FIG. 16 is a plan view showing positions at which the electrode of FIG. 14 is to be cut to form electrode tabs.

FIG. 17 illustrates the electrode cut along the cut line of FIG. 16 to form the tabs.

FIG. 18 illustrates the cross-section cut along line E-E′ of FIG. 16.

### DETAILED DESCRIPTION OF THE EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

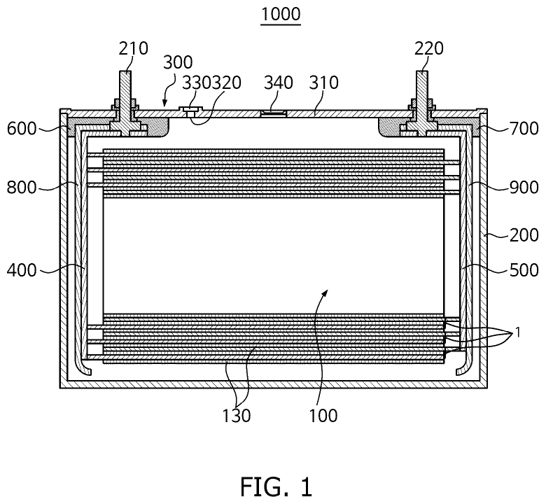

FIG. 1 is a cross-sectional view of an example of a secondary battery according to embodiments of the present disclosure.

The secondary battery 1000 according to one or more embodiments of the present disclosure may include at least one electrode assembly 100 wound with a separator 130 as an insulator between the electrode 1, a case 200 in which the electrode assembly 100 is received (or accommodated) therein, and a cap assembly 300 coupled to an opening of the case 200.

The secondary battery 1000 according to one or more embodiments illustrated in FIG. 1 will now be described as an example of a prismatic lithium ion secondary battery. However, the present disclosure is not limited thereto, and suitable aspects, features and principles described herein may be applied to various other types of batteries, such as lithium polymer batteries and/or cylindrical batteries.

The electrode 1 may include a current collector made of a thin metal foil having a coated portion on which an active material is coated and an uncoated portion 11a, 12a on which an active material is not coated.

The electrode 1 are wound after interposing the separator 130, which is an insulator, therebetween. However, the present disclosure is not limited thereto, and the electrode assembly 100 may have a structure in which the electrode 1 made of a plurality of sheets, are alternately stacked with a separator interposed therebetween.

The case 200 may form the overall outer appearance of the secondary battery 1000 and may be made of a conductive metal, such as aluminum, aluminum alloy, nickel-plated steel, or stainless steel. In addition, the case 200 may provide a space in which the electrode assembly 100 is accommodated.

The cap assembly 300 may include a cap plate 310 covering an opening in the case 200, and the case 200 and the cap plate 310 may be made of a conductive material. The positive and negative electrode terminals 210 and 220 electrically connected to the electrode 1, respectively, may be installed to penetrate (or extend through) the cap plate 310 and protrude outwardly therethrough.

In addition, outer peripheral surfaces (e.g., circumferential surfaces) of upper pillars of the positive and negative electrode terminals 210 and 220 protruding outwardly from the cap plate 31 may be threaded and may be fixed to the cap plate 31 by utilizing nuts.

However, the present disclosure is not limited thereto, and the positive and negative electrode terminals 210 and 220 may have a rivet structure and may be riveted or welded to the cap plate 310.

In addition, the cap plate 310 may be made of a thin plate and may be coupled to the opening in the case 200, and an electrolyte injection port 320 into which a sealing stopper 330 may be installed may be located (e.g., formed) in the cap plate 310, and a vent portion 340 having a notch may be installed.

The positive and negative electrode terminals 210 and 220 may be electrically connected to current collectors 400 and 500 including first and second current collectors 400 and 500 (hereinafter referred to as positive and negative current collectors) by being bonded or coupled (e.g., by welding) to the positive uncoated portion and the negative electrode uncoated portion respectively.

For example, the positive and negative electrode terminals 210 and 220 may be coupled by welding to the positive and negative electrode current collectors 400 and 500, respectively. However, the present disclosure is not limited thereto, and the positive and negative electrode terminals 210 and 220 and the positive and negative electrode current collectors 400 and 500 may be integrally formed in one or more embodiments.

In addition, an insulation member may be installed between the electrode assembly 100 and the cap plate 310. The insulation member may include first and second lower insulation members 600 and 700, and each of the first and second lower insulation members 600 and 700 may also have a portion located between the electrode assembly 100 and the case 200.

In addition, according to one or more embodiments of the present disclosure, one end of a separation member may face one side of the electrode assembly 100 and may be installed between the insulation member and the positive or negative electrode terminals 210 and 220.

In one or more embodiments, the separation member may include first and second separation members 800 and 900.

In such an embodiment, first ends of the first and second separation members 800 and 900 installed to face one side of the electrode assembly 100 may be respectively installed between the first and second lower insulation members 600 and 700 and the positive and negative electrode terminals 210 and 220.

Accordingly, the positive and negative electrode terminals 210 and 220, which may be coupled by welding to the positive and negative electrode current collectors 400 and 500, may be coupled to first ends of the first and second lower insulation members 600 and 700 and the first and second separation members 800 and 900.

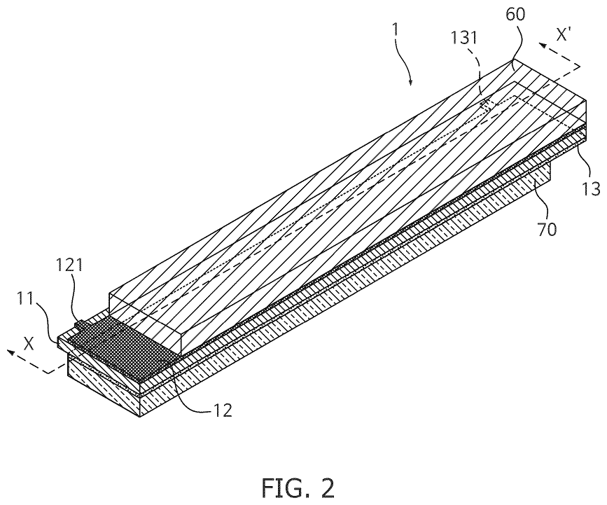

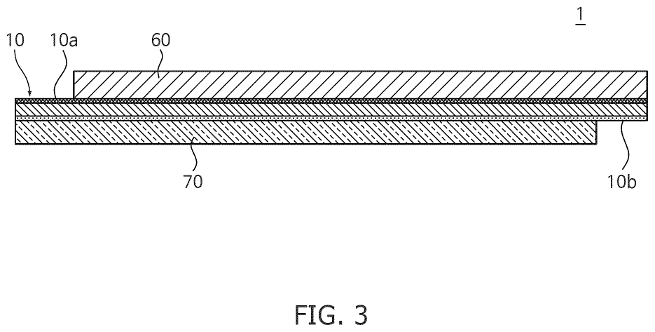

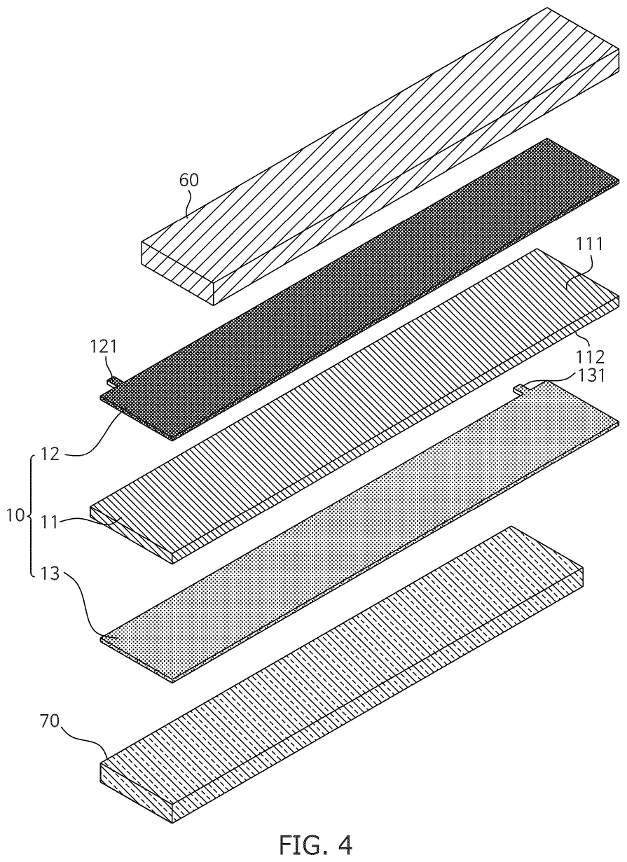

FIG. 2 is a perspective view showing an example of an electrode according to embodiments of the present disclosure. FIG. 3 is a cross-sectional view showing the cross-section of the electrode of FIG. 2, taken along line X-X′. FIG. 4 is an exploded view showing the electrode of FIG. 2.

Referring now to FIGS. 2 to 4, an electrode 1 according to embodiments of the present disclosure may include a substrate layer 10.

The substrate layer 10 may include a polymer layer 11, a first metal layer 12, and a second metal layer 13, with the first metal layer 12 and the second metal layer 13 being disposed on opposite sides of the polymer layer 11. Specifically, the first metal layer 12 may be disposed on a first side 111 of the polymer layer 11, and the second metal layer 13 may be disposed on a second side 112 of the polymer layer 11.

The first metal layer 12 and the second metal layer 13 may be disposed on the polymer layer 11 by coating or deposition. The first metal layer 12 and the second metal layer 13 may be formed integrally with the polymer layer 11. The substrate layer 10 is shown in FIG. 4 as exploded into the polymer layer 11, the first metal layer 12, and the second metal layer 13.

The first metal layer 12 may be disposed on the first side 111 of the polymer layer 11. The first metal layer 12 may include a first tab-forming portion 121 protruding in the transverse direction of the first metal layer 12. The first tab-forming portion 121 may be disposed on the polymer layer 11.

Similarly, the second metal layer 13 may be disposed on the second side 112 of the polymer layer 11. The second metal layer 13 may include a second tab-forming portion 131 protruding in the transverse direction of the second metal layer 13.

Each of the first tab-forming portion 121 and the second tab-forming portion 131 may be disposed on the polymer layer 11. The first tab-forming portion 121 and the second tab-forming portion 131 may protrude in the same direction with respect to the transverse direction of the substrate layer 10. However, the first tab-forming portion 121 and the second tab-forming portion 131 are not limited to the depicted configuration and may protrude in opposite directions with respect to the transverse direction of the substrate layer 10. The first tab-forming portion 121 and the second tab-forming portion 131 be the same length. However, the sizes and shapes of the first tab-forming portion 121 and the second tab-forming portion 131 are not limited to the depicted configuration and may be provided in various shapes.

Each of the first tab-forming portion 121 and the second tab-forming portion 131 may have an approximately rectangular shape. The first tab-forming portion 121 and the second tab-forming portion 131 are shown protruding in a direction perpendicular to the longitudinal direction of the substrate layer 10 but may also protrude at different angles. The shapes of the first tab-forming portion 121 and the second tab-forming portion 131 are not limited to tho the depicted configuration and may be provided in various shapes.

The first metal layer 12 may be coated or deposited on the first side 111 of the polymer layer 11. In such a case, masking may be performed on the first side 111 of the polymer layer 11. Specifically, masking may be performed on one edge of the first side 111 of the polymer layer 11 in the longitudinal direction of the substrate layer 10. In the masking process, portions except for a portion for forming the first tab-forming portion 121 may be masked. That is, the portion for forming the first tab-forming portion 121 may be an unmasked portion.

Although not shown, masking may be performed only on the portion where the first tab-forming portion 121 is to be formed, and the first metal layer 12 may be disposed on the remaining portions. In such a case, the first tab 101 may include the polymer layer 11 and the second metal layer 13.

The first tab-forming portion 121 and the second tab-forming portion 131 may be formed on the unmasked portion of the polymer layer 11. That is, the first metal layer 12 and the second metal layer 13 may be coated or deposited after masking the portions other than the positions where the first tab-forming portion 121 and the second tab-forming portion 131 are to be formed. However, the first tab-forming portion 121 and the second tab-forming portion 131 are not limited in this regard and may be formed by the first metal layer 12 and the second metal layer 13 being formed as a thin film followed by a cutting process such as notching.

The first metal layer 12 and the second metal layer 13 may have a thickness of about 5,000 Å to about 15,000 Å. However, the thicknesses of the first metal layer 12 and the second metal layer 13 are not limited and may vary accordingly in consideration of cell resistance, process time, and the like.

The first metal layer 12 and the second metal layer 13 may be collectors. The first metal layer 12 and the second metal layer 13 may each form a passage for electron movement in conjunction with an active material layer (to be described below).

The electrode 1 according to embodiments of the present disclosure may include a first active material layer 60 and a second active material layer 70.

The first active material layer 60 and the second active material layer 70 may be disposed on the substrate layer 10. Specifically, the first active material layer 60 may be disposed on the first metal layer 12. That is, the first active material layer 60 may be disposed on at least a portion of the first metal layer 12. The second active material layer 70 may be disposed on the second metal layer 13. That is, the second active material layer 70 may be disposed on at least a portion of the second metal layer 13.

The first active material layer 60 may be disposed on at least a portion of the first metal layer 12. A portion where the first active material layer 60 is not disposed on the first metal layer 12 may be referred to as a first uncoated portion 10a. That is, the first uncoated portion 10a may be the portion where the first metal layer 12 is exposed. The substrate layer 10 may include the first uncoated portion 10a where the first metal layer 12 is exposed. That is, the substrate layer 10 may include the first uncoated portion 10a on which the first active material layer 60 is not disposed.

The second active material layer 70 may be disposed on at least a portion of the second metal layer 13. A portion where the second active material layer 70 is not disposed on the second metal layer 13 may be referred to as a second uncoated portion 10b. That is, the second uncoated portion 10b may be the portion where the second metal layer 13 is exposed. The substrate layer 10 may include the second uncoated portion 10b where the second metal layer 13 is exposed. That is, the substrate layer 10 may include the second uncoated portion 10b where the second active material layer 70 is not disposed.

The first uncoated portion 10a and the second uncoated portion 10b may be formed at different positions. Specifically, the first uncoated portion 10a and the second uncoated portion 10b may be positioned opposite to each other with respect to the longitudinal direction of the substrate layer 10. The first uncoated portion 10a may be formed on a first end of the substrate layer 10 in the longitudinal direction of the substrate layer 10. The second uncoated portion 10b may be formed on a second end of the substrate layer 10 in the longitudinal direction of the substrate layer 10.

The first active material layer 60 may be formed by applying a positive or negative electrode active material. The second active material layer 70 may be formed by applying a negative or positive electrode active material. For example, in a case where the first active material layer 60 is formed by applying the positive electrode active material, the second active material layer 70 may be formed by applying the negative electrode active material.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The first active material layer 60 may not be applied to the first tab-forming portion 121 of the first metal layer 12. That is, the first active material layer 60 may be applied to a portion of the first metal layer 12 other than the portion from which the first tab-forming portion 121 protrudes. For example, the first active material layer 60 may be applied after masking along the peripheral edge of the polymer layer 11 where the first tab-forming portion 121 is positioned.

Similarly, the second active material layer 70 may not be applied to the second tab-forming portion 131 of the second metal layer 13. That is, the second active material layer 70 may be applied to a portion of the second metal layer 13 other than the portion from which the second tab-forming portion 131 protrudes. For example, the second active material layer 70 may be applied after masking along the peripheral edge of the polymer layer 11 where the second tab-forming portion 131 is positioned.

The first active material layer 60 and the second active material layer 70 are shown as having the same size, but the present disclosure is not limited to such a configuration. The first active layer 60 and the second active layer 70 may be formed in different sizes, and, in some embodiments, it may be desirable for the active layer corresponding to the negative electrode to be larger than the active layer corresponding to the positive electrode.

The first metal layer 12 may include aluminum (Al), and the second metal layer 13 may include copper (Cu). However, the materials of the first metal layer 12 and the second metal layer 13 are not limited in this regard. For example, in a case where the first active material layer 60 is formed of the negative electrode active material, the first metal layer 12 may include copper (Cu), and in a case where the first active material layer 60 is formed of the positive electrode active material, the first metal layer 12 may include aluminum (Al).

The electrode 1 may include a substrate layer 10 in which the first metal layer 12 and the second metal layer 13 are integrated into the polymer layer 11. The first metal layer 12 and the second metal layer 13 may be in direct contact with the polymer layer 11. Further, the electrode 1 may have the first active material layer 60 and the second active material layer 70 disposed on opposite sides of the substrate layer 10. That is, an integrated electrode 1 in which both a positive electrode and a negative electrode are present on the single electrode 1 may be fabricated.

The electrode 1 according to embodiments of the present disclosure may be miniaturized because the positive electrode and the negative electrode share the substrate layer 10. Furthermore, because the positive electrode and the negative electrode of the electrode 1 are integrated, a problem of the negative electrode not covering the positive electrode may be prevented. That is, the design of the electrode 1 does not require the size of the negative electrode to be larger than the size of the positive electrode, and, thus, the size of the electrode 1 may be reduced.

Because the size of the electrode 1 is miniaturized, more electrodes 1 may be provided in a single cell, which may thereby improve the energy density of the cell.

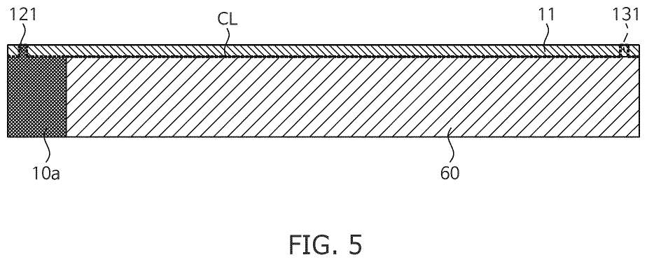

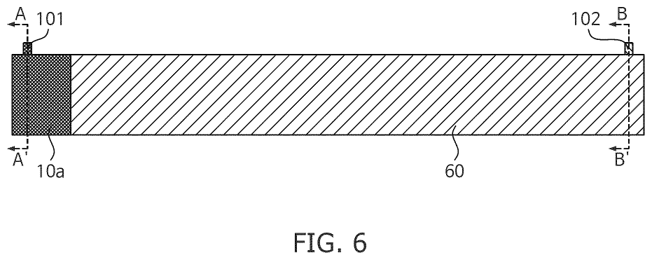

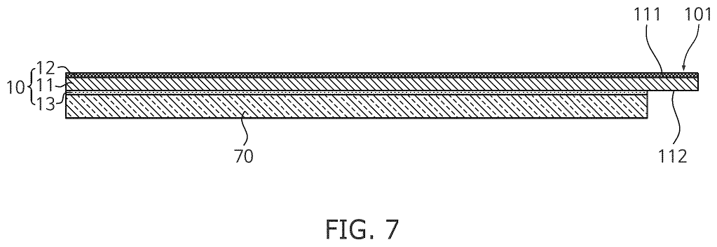

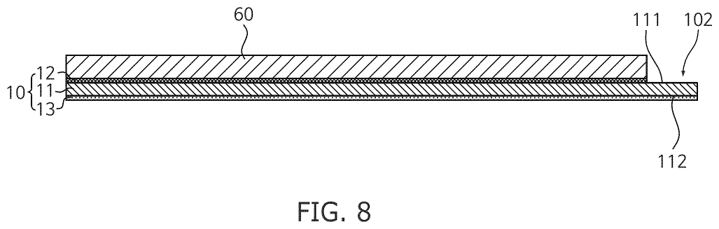

FIG. 5 is a plan view showing positions at which the electrode of FIG. 2 is to be cut to form electrode tabs. FIG. 6 illustrates the electrode cut along the cut line of FIG. 5 to form the tabs. FIG. 7 illustrates the cross-section cut along line A-A′ of FIG. 6. FIG. 8 illustrates the cross-section cut along line B-B′ of FIG. 6.

Referring to FIGS. 5 and 6, the electrode 1 may be cut along a cut line CL to form the first tab 101 and the second tab 102. The cut line CL may be a line along which the substrate layer 10 is cut. The cut line CL may be formed to cut the polymer layer 11 and the first metal layer 12 in the case of forming the first tab 101 and may be formed to cut the polymer layer 11 and the second metal layer 13 in the case of forming the second tab 102.

The cut line CL may extend along the boundary between the first tab-forming portion 121 and the second tab-forming portion 131. However, the cut line CL is not limited to the illustration and may have various shapes in regions other than the first tab-forming portion 121 and the second tab-forming portion 131. The cut line CL may not be formed to cut the first active material layer 60 and the second active material layer 70. However, as the arrangement of the first active material layer 60 and the second active material layer 70 changes, the cut line CL may be formed to cut the first active material layer 60 and the second active material layer 70.

The first tab 101 and the second tab 102 may be formed with the first uncoated portion 10a and the second uncoated portion 10b, respectively. The first tab 101 may be formed on the first end of the substrate layer 10, and the second tab 102 may be formed on the second end of the substrate layer 10. The first end and the second end may each refer to sides the substrate layer. However, the first end and the second end are not limited in this regard and may be formed at other positions.

The first tab 101 may be formed to correspond to the first tab-forming portion 121. The first tab 101 may include the first tab-forming portion 121 and a portion of the polymer layer 11 corresponding to the first tab-forming portion 121. The first tab 101 may be electrically connected to the first active material layer 60. Accordingly, the first tab 101 may not include the second metal layer 13 electrically connected to the second active material layer 70. That is, the first tab 101 may include the first metal layer 12 and the polymer layer 11.

The second tab 102 may be formed to correspond to the second tab-forming portion 131. The second tab 102 may include the second tab-forming portion 131 and a portion of the polymer layer 11 corresponding to the second tab-forming portion 131. The second tab 101 may be electrically connected to the second active material layer 70. Accordingly, the second tab 102 may not include the first metal layer 12 electrically connected to the first active material layer 70. That is, the second tab 102 may include the second metal layer 13 and the polymer layer 11.

The structure of the first tab 101 and the second tab 102 will be described with reference to FIGS. 7 and 8. Referring to FIG. 7, the first tab 101 may include the polymer layer 11 and the first metal layer 12 electrically connected to the first active material layer 60. In a case where the first active material layer 60 is formed of the positive electrode active material, the first tab 101 may be a positive electrode tab. Referring to FIG. 8, the second tab 102 may include the second metal layer 13 and the polymer layer 11 electrically connected to the second active material layer 70. In a case where the second active material layer 70 is formed of the negative electrode active material, the second tab 102 may be a negative electrode tab.

Hereinafter, electrodes according to other embodiments of the present disclosure will be described. The same reference numerals will be used for the same components as in FIGS. 2 to 8, and description thereof may be omitted.

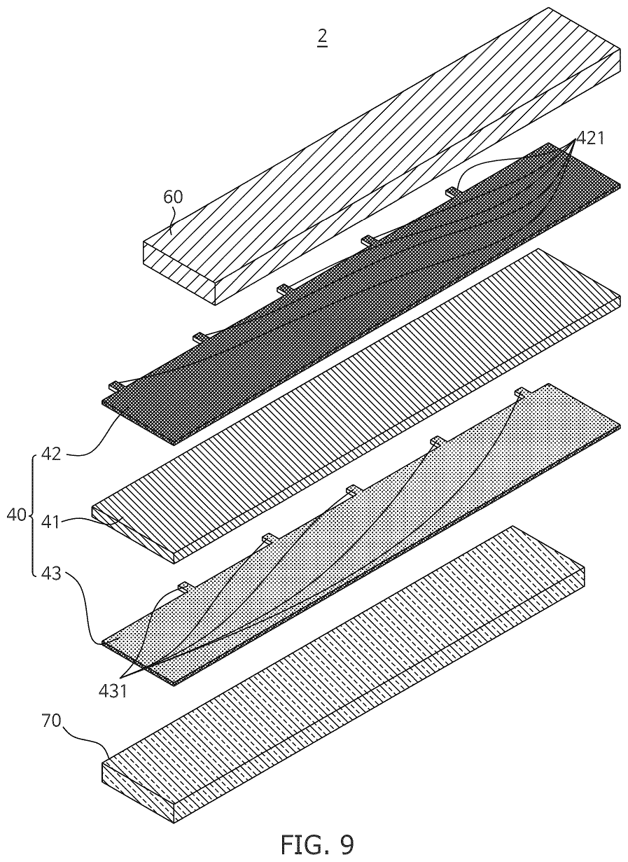

FIG. 9 is an exploded view showing an electrode according to embodiments of the present disclosure.

A substrate layer 40 is shown in FIG. 9 as exploded into a polymer layer 41, a first metal layer 42, and a second metal layer 43. Referring to FIG. 9, the electrode 2 according to embodiments of the present disclosure may include the substrate layer 40.

The substrate layer 40 may include the polymer layer 41, the first metal layer 42, and the second metal layer 43 disposed on opposite sides of the polymer layer 41. The first metal layer 42 and the second metal layer 43 may be coated or deposited on the polymer layer 41. That is, the first metal layer 42 and the second metal layer 43 may be integrated with the polymer layer 41.

The first metal layer 42 may include first tab-forming portions 421. A plurality of the first tab-forming portions 421 may be provided. Similarly, the second metal layer 43 may include a plurality of second tab-forming portions 431. The first tab-forming portions 421 and the second tab-forming portions 431 may be disposed in the longitudinal direction of the substrate layer 40. The first tab-forming portions 421 and the second tab-forming portions 431 may be spaced apart by a predetermined distance.

The first tab-forming portions 421 and the second tab-forming portions 431 may be alternately disposed in the longitudinal direction of the substrate layer 40. Specifically, the second tab-forming portions 431 may be disposed between the first tab-forming portions 421.

The first tab-forming portions 421 and the second tab-forming portions 431 may be formed on an unmasked portion. To alternately form the first tab-forming portions 421 and the second tab-forming portions 431, the masking may also be performed alternately.

In the depicted embodiment, the first tab-forming portions 421 and the second tab-forming portions 431 are disposed in the same direction with respect to the transverse direction of the substrate layer 40, but the present disclosure is not limited to such a configuration. For example, the first tab-forming portions 421 and the second tab-forming portions 431 may be disposed on opposite directions with respect to the transverse direction of the substrate layer 40. That is, the first tab-forming portions 421 and the second tab-forming portions 431 may be formed to protrude in opposite directions with respect to the transverse direction of the substrate layer 40.

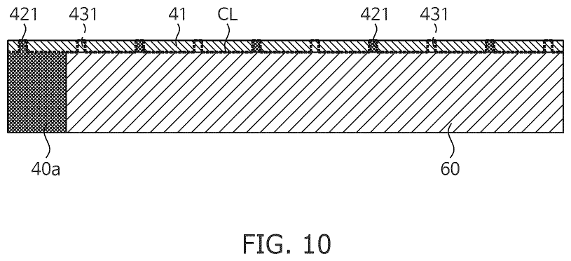

As such, the positions of the first tab-forming portions 421 and the second tab-forming portions 431 are not limited to the embodiment depicted in FIG. 9. But the depicted embodiment will be described with reference to the embodiments shown in FIGS. 10 to 13 for the sake of brevity.

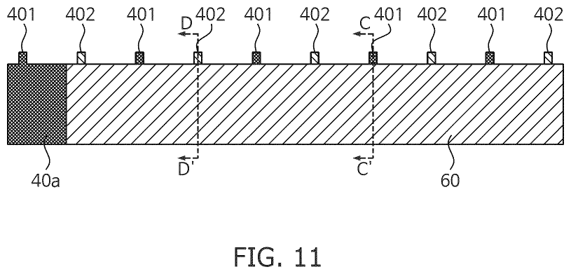

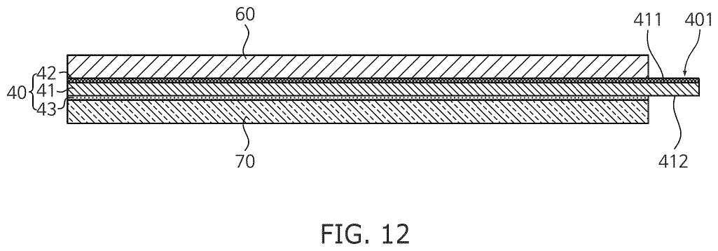

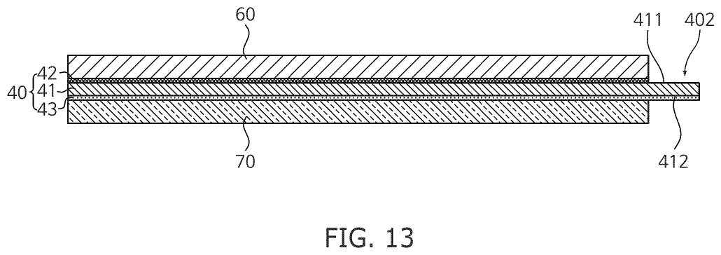

FIG. 10 is a plan view showing positions at which the electrode of FIG. 9 is to be cut to form electrode tabs. FIG. 11 illustrates the electrode cut along the cut line of FIG. 10 to form the tabs. FIG. 12 illustrates the cross-section cut along line C-C′ of FIG. 12. FIG. 13 illustrates the cross-section cut along line D-D′ of FIG. 12.

Referring to FIGS. 10 and 11, the electrode 2 may be cut along the cut line CL to form the first tab 401 and the second tab 402. The cut line CL may extend along the boundary between the first tab-forming portions 421 (see FIG. 9) and the second tab-forming portions 431. However, the cut line CL is not limited to the depicted embodiment and may have various shapes in regions other than the first tab-forming portions 421 and the second tab-forming portions 431.

The first tab 401 may be formed to correspond to the first tab-forming portion 421. The first tab 401 may be electrically connected to the first active material layer 60. Accordingly, the first tab 401 may not include the second metal layer 43 electrically connected to the second active material layer 70. That is, the first tab 401 may include the first metal layer 42 and the polymer layer 11.

The second tab 402 may be formed to correspond to the second tab-forming portion 431. The second tab 401 may be electrically connected to the second active material layer 70. Accordingly, the second tab 402 may not include the first metal layer 42 electrically connected to the first active material layer 60. That is, the second tab 402 may include the second metal layer 43 and the polymer layer 41.

The first tabs 401 and the second tabs 402 may be disposed alternately.

With reference to FIGS. 12 and 13, the structure of the first tabs 401 and the structure of the second tabs 402 will now be described. Cross-sections cut along line C-C′ and line D-D′ (see FIG. 11) are shown to illustrate the structure of an intermediate tab among the first tabs 401 and the structure of an intermediate tab among the second tabs 402.

Referring to FIG. 12, the first tab 401 may include the first metal layer 42 electrically connected to the first active material layer 60 and the polymer layer 41. In a case where the first active material layer 60 is formed of the positive electrode active material, the first tabs 401 may be positive electrode tabs.

Referring to FIG. 13, the second taps 402 may include the second metal layer 43 electrically connected to the second active material layer 70 and the polymer layer 41. In a case where the second active material layer 70 is formed of the negative electrode active material, the second tabs 402 may be negative electrode tabs.

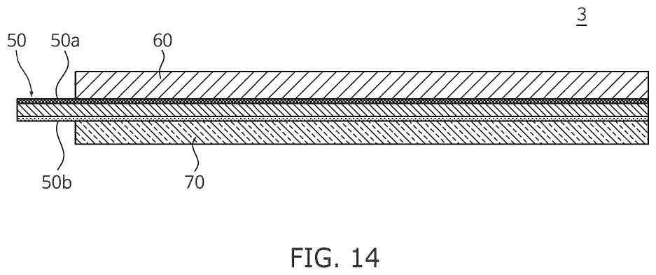

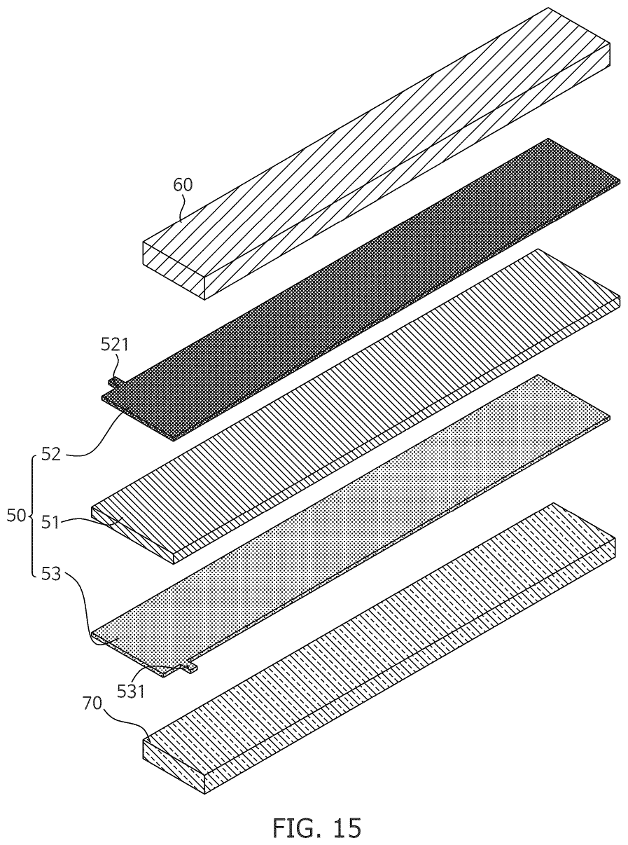

FIG. 14 is a cross-sectional view showing the cross-section of an electrode according to embodiments of the present disclosure. FIG. 15 is an exploded perspective view of the electrode of FIG. 14.

Referring to FIGS. 14 and 15, an electrode 3 according to embodiments of the present disclosure may include a substrate layer 50, a first active material layer 60 disposed on opposite sides of the substrate layer, and a second active material layer 70.

The first active material layer 60 and the second active material layer 70 may be disposed on the substrate layer 50. Specifically, the first active material layer 60 may be disposed on a first metal layer 52. That is, the first active material layer 60 may be disposed on at least a portion of the first metal layer 52. The second active material layer 70 may be disposed on a second metal layer 53. That is, the second active material layer 70 may be disposed on at least a portion of the second metal layer 53.

The first active material layer 60 may be disposed on at least a portion of the first metal layer 52. A portion where the first active material layer 60 is not disposed on the first metal layer 52 may be referred to as a first uncoated portion 50a. That is, the first uncoated portion 50a may be the portion where the first metal layer 52 is exposed. The substrate layer 50 may include the first uncoated portion 50a where the first metal layer 52 is exposed. The substrate layer 50 may include the first uncoated portion 50a on which the first active material layer 60 is not disposed.

The second active material layer 70 may be disposed on at least a portion of the second metal layer 53. A portion where the second active material layer 70 is not disposed on the second metal layer 53 may be referred to as a second uncoated portion 50b. That is, the second uncoated portion 50b may be the portion where the second metal layer 53 is exposed. The substrate layer 50 may include the second uncoated portion 50b where the second metal layer 53 is exposed. The substrate layer 50 may include the second uncoated portion 50b where the second active material layer 70 is not disposed.

The first uncoated portion 50a and the second uncoated portion 50b may be positioned on the same side of the electrode 3. And the first uncoated portion 50a and the second uncoated portion 50b may be formed on opposite sides of the substrate layer 50.

The first uncoated portion 50a may be formed on a first end of the substrate layer 50 in the longitudinal direction of the substrate layer 50. Similarly, the second uncoated portion 50b may be formed on the first end of the substrate layer 50 in the longitudinal direction of the substrate layer 50.

The first metal layer 52 and the second metal layer 53 may be disposed on the polymer layer 51 by coating or deposition. The first metal layer 52 and the second metal layer 53 may be formed integrally with the polymer layer 51. The substrate layer 50 is shown in FIG. 15 as exploded into the polymer layer 51, the first metal layer 52, and the second metal layer 53.

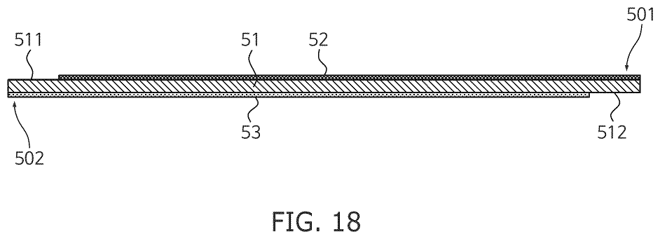

The first metal layer 52 may be disposed on a first side 511 (see FIG. 18) of the polymer layer 51. The first metal layer 52 may include a first tab-forming portion 521 protruding in the transverse direction of the first metal layer 52.

Similarly, the second metal layer 53 may be disposed on a second side 512 of the polymer layer 51. The second metal layer 53 may include a second tab-forming portion 531 protruding in the transverse direction of the second metal layer 53.

The first tab-forming portion 521 and the second tab-forming portion 531 may be disposed on the first face 511 and the second face 512 of the polymer layer 51. The first tab-forming portion 521 and the second tab-forming portion 531 may protrude in opposite directions with respect to the transverse direction of the substrate layer 50. That is, the first tab 501 and the second tab 502 may be formed in opposite directions.

The first tab-forming portion 521 and the second tab-forming portion 531 may be formed by masking before the first metal layer 52 and the second metal layer 53 are disposed on the first surface 511 and the second surface 512. That is, masking may be performed on portions other than the positions where the first metal layer 52 and the second metal layer 53 are to be formed. Because of the masking, the first metal layer 52 and the second metal layer 53 may not be coated or deposited on portions other than the first tab-forming portion 521 and the second tab-forming portion 531. However, the first tab-forming portion 521 and the second tab-forming portion 531 are not limited in this regard, and the first metal layer 52 and the second metal layer 53 may be formed as a thin film followed by cutting process such as notching.

The first tab-forming portion 521 and the second tab-forming portion 531 may be formed at the same position in the longitudinal direction of the substrate layer 50. Further, the first tab-forming portion 521 and the second tab-forming portion 531 may be formed in opposite directions with respect to the transverse direction of the substrate layer 50.

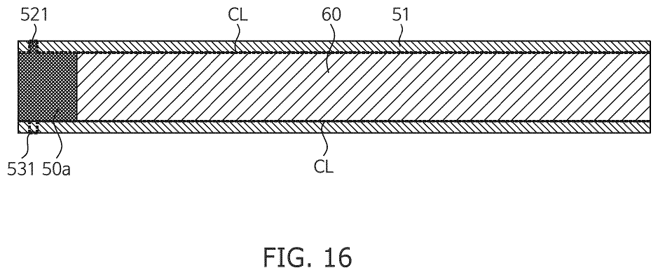

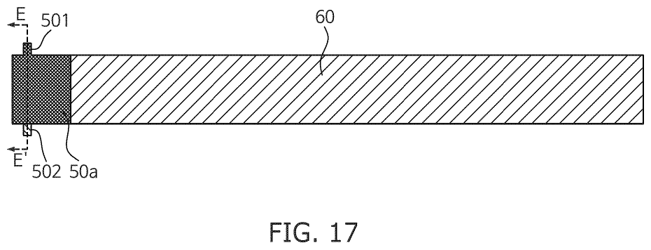

FIG. 16 is a plan view showing positions at which the electrode of FIG. 14 is to be cut to form electrode tabs. FIG. 17 illustrates the electrode cut along the cut line of FIG. 16 to form the tabs. FIG. 18 illustrates the cross-section cut along line E-E′ of FIG. 16.

Referring to FIGS. 16 to 18, the first tab 501 and the second tab 502 may be formed on the first uncoated portion 50a and the second uncoated portion 50b, respectively. The first tab 501 and the second tab 502 may be formed at the first end of the substrate layer 50. However, the first tab 501 and the second tab 502 are not limited to the depicted configuration and may also be formed at other positions.

The first tab 501 and the second tab 502 may be formed to correspond to the first tab-forming portion 521 and the second tab-forming portion 531, respectively. The first tab 501 and the second tab 502 may be electrically connected to the first active material layer 60 and the second active material layer 70, respectively.

The first tab 501 may not include the second metal layer 53 electrically connected to the second active material layer 70. That is, the first tab 501 may include the first metal layer 52 and the polymer layer 51. Similarly, the second tab 502 may not include the first metal layer 52 electrically connected to the first active material layer 60. That is, the second tab 502 may include the second metal layer 53 and the polymer layer 51.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. An electrode comprising:
a substrate layer including a polymer layer, a first metal layer disposed on a first surface of the polymer layer, and a second metal layer disposed on a second surface of the polymer layer that is opposite to the first surface, the second metal layer comprising a different metal from the first metal layer;
a first active material layer disposed on the first metal layer; and
a second active material layer disposed on the second metal layer,
wherein the substrate layer includes a first uncoated portion where the first metal layer is exposed and a second uncoated portion where the second metal layer is exposed.

2. The electrode as claimed in claim 1, wherein the first uncoated portion is provided at a first end of the substrate layer in a longitudinal direction of the substrate layer, and the second uncoated portion is provided at a second end of the substrate layer.

3. The electrode as claimed in claim 2, wherein the first metal layer comprises a tab-forming portion protruding in a transverse direction of the first metal layer.

4. The electrode as claimed in claim 3, wherein the substrate layer comprises a tab formed by the tab-forming portion and a portion of the polymer layer corresponding to the first tab-forming portion.

5. The electrode as claimed in claim 4, wherein the tab-forming portion is a first tab-forming portion, and
wherein the second metal layer further comprises a second tab-forming portion protruding in a transverse direction of the second metal layer.

6. The electrode as claimed in claim 5, wherein the tab is a first tab, and
wherein the substrate layer comprises a second tab formed of the second tab-forming portion and a portion of the polymer layer corresponding to the second tab-forming portion.

7. The electrode as claimed in claim 6, wherein the first tab comprises a plurality of first tabs and the second tab comprises a plurality of second tabs, and
wherein the first tabs and the second tabs are arranged in the longitudinal direction of the substrate layer.

8. The electrode as claimed in claim 7, wherein the first tabs and the second tabs are alternately disposed.

9. The electrode as claimed in claim 1, wherein the first uncoated portion and the second uncoated portion are disposed on the same side of the substrate layer.

10. The electrode as claimed in claim 9, wherein the substrate layer comprises a first tab and a second tab protruding in opposite directions with respect to a transverse direction of the substrate layer.

11. The electrode as claimed in claim 1, wherein the first metal layer and the second metal layer are deposited on the polymer layer.

12. An electrode assembly comprising:
a plurality of electrodes; and
separators disposed between the electrodes,
wherein each of the electrodes comprises:
a substrate layer including a polymer layer, a first metal layer disposed on a first surface of the polymer layer, and a second metal layer disposed on a second surface of the polymer layer that is opposite to the first surface, the second metal layer comprising a different metal from the first metal layer;
a first active material layer disposed on the first metal layer; and
a second active material layer disposed on the second metal layer,
wherein the substrate layer includes a first uncoated portion where the first metal layer is exposed and a second uncoated portion where the second metal layer is exposed.

13. A method of manufacturing an electrode, the method comprising:
forming a substrate layer by disposing a first metal layer on a first surface of a polymer layer and disposing a second metal layer on a second surface of the polymer layer that is opposite to the first surface, the second metal layer comprising a different metal from the first metal layer;
disposing a first active material layer on the first metal layer to form a first uncoated portion on the substrate layer; and
disposing a second active material layer on the second metal layer to form a second uncoated portion on the substrate layer.

14. The method as claimed in claim 13, wherein the first uncoated portion is provided at a first end of the substrate layer in a longitudinal direction of the substrate layer, and the second uncoated portion is provided at a second end of the substrate layer.

15. The method as claimed in claim 14, wherein forming the substrate layer further comprises disposing the first metal layer on a portion of the polymer layer to form a tab-forming portion protruding in a transverse direction of the first metal layer.

16. The method as claimed in claim 15, further comprising forming a tab by cutting the substrate layer corresponding to the tab-forming portion.

17. The method as claimed in claim 16, wherein the tab-forming portion is a first tab-forming portion, and
wherein the forming the substrate layer further comprises disposing the second metal layer on a portion of the polymer layer to form a second tab-forming portion protruding in a transverse direction of the second metal layer.

18. The method as claimed in claim 17, wherein the tab is a first tab, and
wherein the method further comprises forming a second tab by cutting the substrate layer corresponding to the second tab-forming portion.

19. The method as claimed in claim 13, wherein forming the substrate layer comprises depositing the first metal layer on the first surface and depositing the second metal layer on the second surface.

20. The method as claimed in claim 13, wherein the first metal layer comprises aluminum (Al) and the second metal layer comprises copper (Cu).
